(19) United States
(12) Patent Application Publication
(10) Pub. No.: US 2026/0301112 A1
(43) Pub. Date: Oct. 1, 2026

(54) SYSTEMS AND METHODS FOR MASSIVE PARALLELIZATION OF MEMETIC-TABU SEARCH

(71) Applicant: JPMORGAN CHASE BANK, N.A., New York, NY (US)

(72) Inventors: Zhiwei ZHANG, Manhattan, NY (US); Jiayu SHEN, New York, NY (US); Abhishek SOM, Allston, MA (US); Niraj KUMAR, Amsterdam (NL); Marco PISTOIA, New York, NY (US)

(21) Appl. No.: 19/631,268

(22) Filed: Mar. 27, 2026

Related U.S. Application Data
(60) Provisional application No. 63/778,851, filed on Mar. 27, 2025.

(51) Int. Cl. G06T 1/60; G06F 9/54; G06F 12/02; G06F 17/11

(52) U.S. Cl. CPC G06T 1/60; G06F 9/544; G06F 12/0292; G06F 17/11

(57) ABSTRACT

A method may include generating, for each block of shared memory in a GPU, random sequences as bit vectors in a population; initializing a tableC as a bit vector and a vectorC as an integer vector in the shared memory; recombining two parent sequences into a child sequence; mutating the child sequence; initializing a tabuList as an integer vector in shared memory that manages when each bit in the child sequence is allowed to move; iteratively performing, using threads in the blocks, a parallelized tabu search by checking a neighbor of the child sequence by flipping one bit and keeping track of a best non-tabu move; choosing the best non-tabu move; updating, by the threads, a row of tableC; replacing a random individual in the population with a best sequence from the parallelized tabu search; and terminating in response to a target energy being reached.

### RELATED APPLICATIONS

This application claims priority to, and the benefit of, U.S. Provisional Patent Application Ser. No. 63/778,851, filed Mar. 27, 2026, the disclosure of which is hereby incorporated, by reference, in its entirety.

### BACKGROUND OF THE INVENTION

### 1. Field of the Invention

Embodiments relate to systems and methods for massive parallelization of memetic-tabu search.

### 2. Description of the Related Art

Combinatorial optimization problems (COPs) are a cornerstone of a multitude of modern real world applications including graph coloring, vehicle routing problems, traveling salesman problems, quadratic assignment problems, large optimization problems on hundreds of heterogeneous machines, and many other problems. Unfortunately, the majority of the COPs with real world importance are in general difficult to formulate and can be intractable to solve exactly, i.e., they belong to the NP hard complexity class meaning the time to find the exact solution grows exponentially in the problem size. Among the exact COP solving methods, particularly for small problem instances, exhaustive search, and branch-and-bound methods are especially prominent.

Given the intractability of solving large scale COPs exactly, past half a century has seen a surge of approximation algorithms, also called metaheuristics, in providing a pathway to solving a multitude of COPs by efficiently exploring its search space and maintaining small search history. Among the popular state of art metaheuristics, include simulated annealing, Kernighan-Lin, evolutionary, tabu search, memetic tabu, self-avoiding walks, and so on.

Metaheuristic methods have no guarantee for optimality of the solution, unlike exact methods, and metaheuristic local search methods such as tabu search and self-avoiding walk may have the issue of being trapped by a local minimum and thus not finding the global minimum. However, such methods are often parallelizable, so that the total wall clock runtime can be largely reduced, while exact methods like branch-and-bound cannot leverage parallel computation as much and therefore run much slower. As an example, parallelization has been used for self-avoiding walks to solve Low Autocorrelation Binary Sequence (LABS) on CPUs and GPUs.

In the context of Memetic Tabu search applied to the LABS problem is run on CPU with parallelization. Tabu search is parallelized for graph coloring, vehicle routing problems, traveling salesman problems, quadratic assignment problems, large optimization problems on hundreds of heterogeneous machines, and many other problems.

### SUMMARY OF THE INVENTION

Systems and methods for massive parallelization of memetic-tabu search are disclosed. According to an embodiment, a method may include generating, by a computer program, and for each block of shared memory in a graphical processing unit, a plurality of random sequences as bit vectors in a population; initializing, by the computer program, a tableC as a bit vector and a vectorC as an integer vector in the shared memory; choosing, by the computer program, two parent sequences from the population; recombining, by the computer program, the two parent sequences into a child sequence; mutating, by the computer program, the child sequence; initializing, by the computer program, a tabuList as an integer vector in shared memory, wherein the tabuList manages when each bit in the child sequence is allowed to move; iteratively performing, by the computer program and using threads in the blocks, a parallelized tabu search by checking a neighbor of the child sequence by flipping one bit and keeping track of a best non-tabu move; choosing, by the threads, the best non-tabu move; updating, by the threads, a row of tableC; replacing, by the computer program, a random individual in the population with a best sequence from the parallelized tabu search; checking, by the computer program, if a target energy is reached; and terminating, by the computer program, in response to the target energy being reached.

In one embodiment, the tableC may include a binary matrix and vectorC may include an integer.

In one embodiment, the child sequence may be mutated by flipping each bit of the child sequence by a probability.

In one embodiment, the tabuList maps each bit of the child sequence in the parallelized tabu search to a future time represented as a number of an iteration.

In one embodiment, the best non-tabu move may include a best move among allowed types of moves that are managed by the tabuList.

In one embodiment, the best non-tabu move may include a direction of the best non-tabu move.

In one embodiment, the target energy may include an objective function to be minimized or maximized.

According to another embodiment, a system may include: a data source; and a graphical processing unit kernel that may be configured to generate, for each block of shared memory in the graphical processing unit, a plurality of random sequences as bit vectors in a population; to initialize a tableC as a bit vector and a vectorC as an integer vector in the shared memory; to choose two parent sequences from the population; to recombine the two parent sequences into a child sequence; to mutate the child sequence; to initialize a tabuList as an integer vector in shared memory, wherein the tabuList manages when each bit in the child sequence is allowed to move; to iteratively perform, using threads in the blocks, a parallelized tabu search by checking a neighbor of the child sequence by flipping one bit and keeping track of a best non-tabu move; to choose the best non-tabu move; to update a row of tableC; to replace a random individual in the population with a best sequence from the parallelized tabu search; to check if a target energy is reached; and to terminate in response to the target energy being reached.

In one embodiment, the tableC may include a binary matrix and vectorC may include an integer.

In one embodiment, the child sequence may be mutated by flipping each bit of the child sequence by a probability.

In one embodiment, the tabuList maps each bit of the child sequence in the parallelized tabu search to a future time represented as a number of an iteration.

In one embodiment, the best non-tabu move may include a best move among allowed types of moves that are managed by the tabuList.

In one embodiment, the best non-tabu move may include a direction of the best non-tabu move.

In one embodiment, the target energy may include an objective function to be minimized or maximized.

According to another embodiment, a non-transitory computer readable storage medium may include instructions stored thereon, which when read and executed by one or more computer processors, cause the one or more computer processors to perform steps comprising: generating for each block of shared memory in a graphical processing unit, a plurality of random sequences as bit vectors in a population; initializing a tableC as a bit vector and a vectorC as an integer vector in the shared memory; choosing two parent sequences from the population; recombining the two parent sequences into a child sequence; mutating the child sequence; initializing a tabuList as an integer vector in shared memory, wherein the tabuList manages when each bit in the child sequence is allowed to move; iteratively performing, using threads in the blocks, a parallelized tabu search by checking a neighbor of the child sequence by flipping one bit and keeping track of a best non-tabu move; choosing the best non-tabu move; updating a row of tableC; replacing a random individual in the population with a best sequence from the parallelized tabu search; checking if a target energy is reached, wherein the target energy may include an objective function to be minimized or maximized; and terminating in response to the target energy being reached.

In one embodiment, the tableC may include a binary matrix and vectorC may include an integer.

In one embodiment, the child sequence may be mutated by flipping each bit of the child sequence by a probability.

In one embodiment, the tabuList maps each bit of the child sequence in the parallelized tabu search to a future time represented as a number of an iteration.

In one embodiment, the best non-tabu move may include a best move among allowed types of moves that are managed by the tabuList.

In one embodiment, the best non-tabu move may include a direction of the best non-tabu move.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for massive parallelization of memetic-tabu search according to an embodiment;

FIG. 2 illustrates a method for massive parallelization of memetic-tabu search according to an embodiment;

FIG. 3 depicts an exemplary computing system for implementing aspects of the present disclosure.

### DETAILED DESCRIPTION OF PREFERRED EMBODIMENTS

Embodiments are directed to systems and methods for massive parallelization of memetic-tabu search.

Tabu search is a local search method that enhances the search process by using memory structures to avoid revisiting previously explored solutions. The combination of memetic and tabu search allows for effective exploration and exploitation of the solution space, balancing between diversification and intensification to find high-quality solutions.

Embodiments may provide unified replica-based execution across processing architectures. For example, a parallel execution model may be defined in terms of independent solver replicas that map to processing units, including GPU blocks and CPU cores or threads, each replica maintaining private population state, local search structures, and auxiliary evaluation data. This formulation enables consistent decomposition of the optimization process across architectures while preserving locality of computation and data within each replica. The CPU model extends the formulation to support integer variables as well.

Embodiments may provide synchronization-free parallel search with minimal global coordination. Replicas evolve independently without per-iteration synchronization, locking, or migration, and perform local search using incremental evaluation supported by replica-local data structures. Coordination is restricted to a shared mechanism for publishing the final solution and propagating termination signals, thereby eliminating coordination overhead while enabling scalable execution across CPU, GPU, or heterogeneous systems.

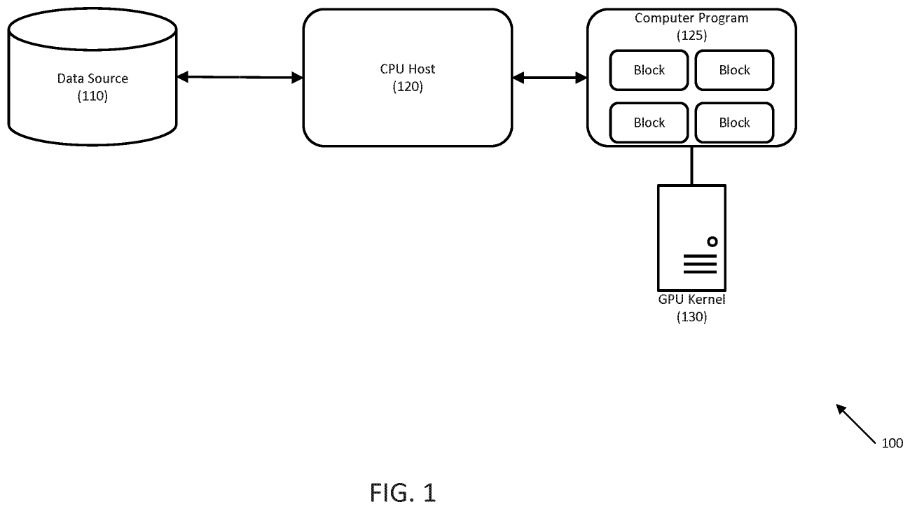

Referring to FIG. 1, a system for massive parallelization of memetic-tabu search is disclosed according to an embodiment. System 100 may include data source 110, such as a database, a system of record, a computer system, a computer program/application, etc. Data source 110 may provide data to generate/instantiate problem instances (and later in the pipeline, the algorithm takes the problem instances to solve them).

System 100 may include graphical processing unit (GPU) kernel 130, such as a graphical processing unit (GPU). The parallel nature of GPUs makes them well-suited for accelerating computationally intensive tasks. The memetic algorithm and Tabu search may be implemented on a GPU to take advantage of its parallel processing capabilities, significantly reducing the time required to find optimal solutions.

GPU kernel 130 may include global memory and a grid. The grid may include a plurality of blocks, with each block providing shared memory for that block and executing a plurality of threads.

A single GPU can host thousands of blocks, allowing for the execution of thousands of algorithm replicas in parallel. This massive replication enhances the exploration of the solution space and increases the likelihood of finding optimal solutions quickly. Each block of the GPU may run a memetic-tabu algorithm independently. By assigning different random seeds to each block, the algorithm explores diverse regions of the solution space simultaneously.

The program may terminate as soon as any block reaches a predefined termination criterion, such as achieving a target solution quality. This early termination mechanism ensures efficient use of computational resources.

Each block is equipped with multiple threads within to perform tasks in parallel in the Tabu Search process. Examples of tasks may include computing energy for a neighbor of a search pivot, updating a part of a data structure, initializing a part of a population, etc. This parallelization of neighborhood evaluation accelerates the search process and improves the algorithm's efficiency. By implementing these strategies, embodiments significantly reduce the time required to find optimal solutions.

Unlike most GPU programs that rely on global memory, most of the data structures are deployed on the GPU's shared memory, which offers much faster access times. As the size of shared memory for each block is limited, embodiments may use compact bit-vectors to store binary values, minimizing memory usage and maximizing the number of active blocks.

Embodiments are fully deployed on the GPU, avoiding the overhead from switching between GPU and CPUs.

The following data structures are stored in the shared memory for each block: (1) the population in the memetic algorithm (e.g., Size=popSize*N bits); a data structure for computing the energy (also known as the objective function) in linear time, such as a matrix left upper-triangle having a Size=(N+1)*N/2 bits; (3) tabuList size=N integers.

In the context of optimization, the objective function is a quantity to be optimized (maximized or minimized). Conventionally, minimization problems are more common than the maximization problems (which would be mathematically equivalent to minimizing the objective function with an extra “minus sign”). Relate to this, in the context of physical sciences, the “energy” is often a quantity that tends to be minimized, and a lot of optimization problems can be mathematically mapped to minimizing some energies of a physical system. Objective functions and energies are more of a commonly used conventional language that in this context used almost interchangeably.

System 100 may also include CPU host 120, which may be a server (e.g., physical and/or cloud-based), a computer (e.g., workstation, desktop, laptop, notebook, tablet, etc.), etc. CPU host 120 may trigger and control the executions of the computer program 125 executed GPU kernel 130.

Computer program 125 may include a single kernel MemeticTabu. In the kernel, each thread block runs a replica of memetic tabu search algorithm. The fast-but-small shared memory in each block, which can be accessed by all threads, is fully exploited by storing data structures such as tabuList, tableC and population. In each block, the computationally heavy steps are parallelized by multiple threads in a block. Early termination is enabled by storing the global termination flag (GLF) as well as the best sequence and its energy, in the global memory of GPU. When a block reaches the target value, it sets the GLF, which is accessible by other blocks, such that all blocks can shut down. The blocks only communicate by setting and reading the global termination flag (GLF).

In one embodiment, the computational work may be performed on GPU kernel 130, which avoids data transportation and host-device switching. CPU host 120 may manage the execution of computer program 125 GPU kernel 130.

In another embodiment, CPU host 120 may perform all functions. Thus, embodiments disclosed herein may be processing-unit-architecture-independent and translate to CPUs as well, very effectively.

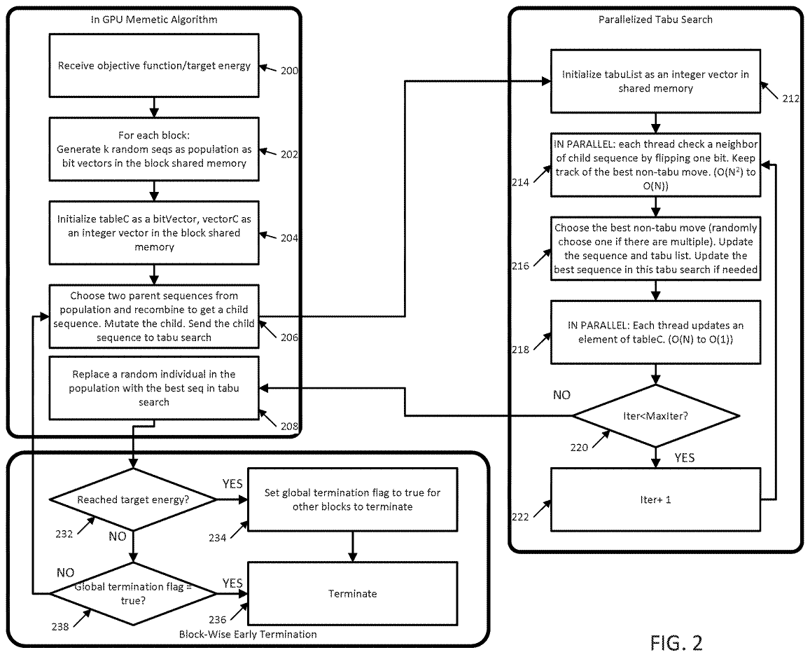

Referring to FIG. 2, a method for massive parallelization of memetic-tabu search is disclosed according to an embodiment.

In step 200, a computer program executed by a CPU host may receive an objective function/target energy from a user. The objective function may be based on the LABS problem; other applications to other instantiations of the objective function (integer case, etc.) may be used as is necessary and/or desired.

In step 202, for each block, the computer program may generate a plurality of random sequences (k) of bit vectors for a population in the block shared memory of the GPU.

In step 204, the computer program may initialize a tableC as a bit Vector, and a vectorC as an integer vector in the block shared memory. tableC and vectorC are data structures that help efficiently compute the energy function of neighborhoods in tabu search, which is the most computational work in the memetic tabu search algorithm. tableC is a N×N binary matrix and vectorC is an integer vector of length N. N represents the problem size, i.e., how large any candidate solution is, such as the number of bits.

In step 206, the computer program may choose two parent sequences from the population and may recombine them to get a child sequence. It may then mutate the child sequence, and send the child sequence to tabu search.

In one embodiment, the mutation involves each bit of the child sequence being flipped by probability p=1/N. Specifically, each “child sequence” contains N bits. For each bit in this child, during mutation, there is a probability p=1/N of flipping (i.e., if the bit was originally 0, it gets flipped to 1; If the bit was originally 1, it gets flipped to 0).

As a local search algorithm, tabu search needs a sequence to start its search from. Therefore, the child sequence is used as the starting point of the tabu search.

In step 212, the computer program may initialize tabuList as an integer vector in shared memory. The tabuList that manages when each bit from the child sequence will be allowed to move. For example, the tabuList may map each bit of the child sequence in the tabu search to a future time represented as a number of an iteration, representing when the coordinate will be allowed to get flipped again. After a flip is made in tabu search, the tabuList is updated to ban the flip of the same bit for a random amount of iterations.

In step 214, in parallel, each thread may check a neighbor of the child sequence by flipping one bit. The thread may keep track of the best non-tabu move, (O(N²) to O(N)). O is the big O notation. O(N²) and O(N) represent any function of N that is asymptotically (when N is large) proportional to N² and N, respectively. Each form of the functions is unspecified, while the orders O (e.g., when N is large) are important.

For example, in each iteration of the tabu search, which is essentially a local search where the search steps are restricted by the tabu table, the algorithm checks the energy of all N neighborhoods of the current search pivot and greedily select the best bit to flip unless it is forbidden by the tabuList in this iteration. Checking the energy of each neighborhood takes O(N) time. Therefore, in previous implementations, checking all N neighborhoods takes O( )=N×NO(N²) time. In embodiments, however, checking the energy of all N neighborhoods are done simultaneously. Therefore, the time needed for checking all N neighborhoods is O(N).

The tabuList tracks for each bit, what is the earliest time for each bit to be allowed to be moved (flipped). At step 214, there will be N possible moves that correspond to N bits, respectively. Some of these moves are forbidden (tabu-ed) and the rest of the moves are allowed (non-tabu), depending on the current status of the tabuList.

In step 216, the computer program may choose the best non-tabu move. If there are multiple, one may be randomly chosen. The computer program may update the sequence and the tabuList, and may update the best sequence in this tabu search if needed.

In step 218, in parallel, each thread may update an element of tableC. In tabu search, after each flip, a row of tableC (N elements) needs to be updated. In previous implementation, those N elements are updated sequentially thus taking O(N) time. In embodiments, updating those elements can be done parallelly by N threads which reduces the time needed to O(1).

In step 220, if the number of iterations is less than the maximum number of iterations, in step 222, the number of iterations is increased, and the process returns to step 214.

If the number of iterations is not less than the maximum number of iterations, in step 208, the computer program may replace a random individual bit vectors in the population with the best sequence found during all iterations of the parallelized tabu search loop, best among all sequences the algorithm has seen in the maximum number of iterations.

Next, in step 232, a check is made to see if the target energy is reached. The energy refers to the objective function—the function to be minimized/maximized via an optimization algorithm/solver/computer program.

If it is, in step 234, the computer program may set the global termination flag to true, and the process terminates in step 236.

In one embodiment, the target energy may be provided by the user and represents the target energy to achieve. The energy, E(S), may be defined as the quadratic sum of the aperiodic autocorrelations of a binary sequence S of length L, such as:

$$E ( S ) = {\sum }_{k = 1}^{L} {c}_{K}^{2} ( S )$$

where the aperiodic autocorrelation with distance k is defined as

$${C}_{k} ( S ) = {\sum }_{i = 1}^{N - k} {s}_{i} {s}_{i + k}$$

With the target energy being an input from the user, the task of optimization for memetic-tabu search is to find a sequence S that yields the value of E(S) such that E(S)≤target energy.

If the target energy is not reached, but in step 238, the global termination flag is true, the process terminates in step 236.

If the target energy is not reached, and the global termination flag is not true, then the process returns to step 216.

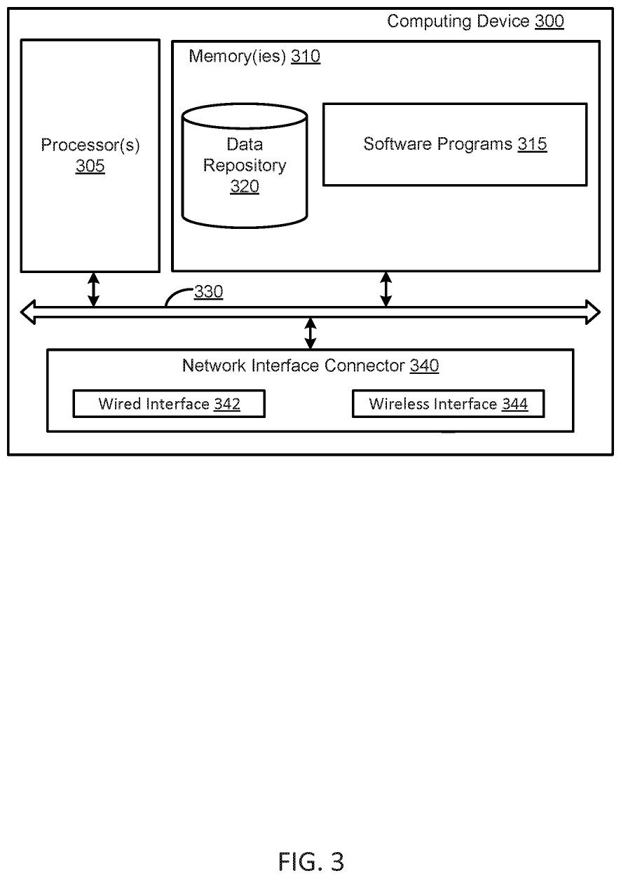

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Although several embodiments have been disclosed, it should be recognized that these embodiments are not exclusive to each other, and features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

What is claimed is:

1. A method, comprising:
generating, by a computer program, and for each block of shared memory in a graphical processing unit, a plurality of random sequences as bit vectors in a population;
initializing, by the computer program, a tableC as a bit vector and a vectorC as an integer vector in the shared memory;
choosing, by the computer program, two parent sequences from the population;
recombining, by the computer program, the two parent sequences into a child sequence;
mutating, by the computer program, the child sequence;
initializing, by the computer program, a tabuList as an integer vector in shared memory, wherein the tabuList manages when each bit in the child sequence is allowed to move;
iteratively performing, by the computer program and using threads in the blocks, a parallelized tabu search by checking a neighbor of the child sequence by flipping one bit and keeping track of a best non-tabu move;
choosing, by the threads, the best non-tabu move;
updating, by the threads, a row of tableC;
replacing, by the computer program, a random individual in the population with a best sequence from the parallelized tabu search;
checking, by the computer program, if a target energy is reached; and
terminating, by the computer program, in response to the target energy being reached.

2. The method of claim 1, wherein the tableC comprises a binary matrix and vectorC comprises an integer.

3. The method of claim 1, wherein the child sequence is mutated by flipping each bit of the child sequence by a probability.

4. The method of claim 1, wherein the tabuList maps each bit of the child sequence in the parallelized tabu search to a future time represented as a number of an iteration.

5. The method of claim 1, wherein the best non-tabu move comprises a best move among allowed types of moves that are managed by the tabuList.

6. The method of claim 5, wherein the best non-tabu move comprises a direction of the best non-tabu move.

7. The method of claim 1, wherein the target energy comprises an objective function to be minimized or maximized.

8. A system, comprising:
a data source; and
a graphical processing unit kernel that is configured to generate, for each block of shared memory in the graphical processing unit, a plurality of random sequences as bit vectors in a population; to initialize a tableC as a bit vector and a vectorC as an integer vector in the shared memory; to choose two parent sequences from the population; to recombine the two parent sequences into a child sequence; to mutate the child sequence; to initialize a tabuList as an integer vector in shared memory, wherein the tabuList manages when each bit in the child sequence is allowed to move; to iteratively perform, using threads in the blocks, a parallelized tabu search by checking a neighbor of the child sequence by flipping one bit and keeping track of a best non-tabu move; to choose the best non-tabu move; to update a row of tableC; to replace a random individual in the population with a best sequence from the parallelized tabu search; to check if a target energy is reached; and to terminate in response to the target energy being reached.

9. The system of claim 8, wherein the tableC comprises a binary matrix and vectorC comprises an integer.

10. The system of claim 8, wherein the child sequence is mutated by flipping each bit of the child sequence by a probability.

11. The system of claim 8, wherein the tabuList maps each bit of the child sequence in the parallelized tabu search to a future time represented as a number of an iteration.

12. The system of claim 8, wherein the best non-tabu move comprises a best move among allowed types of moves that are managed by the tabuList.

13. The system of claim 12, wherein the best non-tabu move comprises a direction of the best non-tabu move.

14. The system of claim 8, wherein the target energy comprises an objective function to be minimized or maximized.

15. A non-transitory computer readable storage medium, including instructions stored thereon, which when read and executed by one or more computer processors, cause the one or more computer processors to perform steps comprising:
generating for each block of shared memory in a graphical processing unit, a plurality of random sequences as bit vectors in a population;
initializing a tableC as a bit vector and a vectorC as an integer vector in the shared memory;
choosing two parent sequences from the population;
recombining the two parent sequences into a child sequence;
mutating the child sequence;
initializing a tabuList as an integer vector in shared memory, wherein the tabuList manages when each bit in the child sequence is allowed to move;
iteratively performing, using threads in the blocks, a parallelized tabu search by checking a neighbor of the child sequence by flipping one bit and keeping track of a best non-tabu move;
choosing the best non-tabu move;
updating a row of tableC;
replacing a random individual in the population with a best sequence from the parallelized tabu search;
checking if a target energy is reached, wherein the target energy comprises an objective function to be minimized or maximized; and
terminating in response to the target energy being reached.

16. The non-transitory computer readable storage medium of claim 15, wherein the tableC comprises a binary matrix and vectorC comprises an integer.

17. The non-transitory computer readable storage medium of claim 15, wherein the child sequence is mutated by flipping each bit of the child sequence by a probability.

18. The non-transitory computer readable storage medium of claim 15, wherein the tabuList maps each bit of the child sequence in the parallelized tabu search to a future time represented as a number of an iteration.

19. The non-transitory computer readable storage medium of claim 15,
wherein the best non-tabu move comprises a best move among allowed types of moves that are managed by the tabuList.

20. The non-transitory computer readable storage medium of claim 19, wherein the best non-tabu move comprises a direction of the best non-tabu move.
